(19) United States
(12) Patent Application Publication
(10) Pub. No.: US 2020/0372033 A1
(43) Pub. Date: Nov. 26, 2020

(54) WEARING OBJECT DESIGN INFORMATION SEARCH SYSTEM AND SUIT DESIGN INFORMATION SEARCH SYSTEM

(71) Applicant: R-E Co., Ltd., Tokyo (JP)

(72) Inventors: Yasunari NAKAJIMA, Tokyo (JP); Kouji EMORI, Tokyo (JP)

(21) Appl. No.: 16/635,393

(22) PCT Filed: Jul. 25, 2018
(86) PCT No.: PCT/JP2018/027812

§ 371 Date: Jan. 30, 2020

(30) Foreign Application Priority Data
Aug. 30, 2017 (JP) 2017165819
Mar. 28, 2018 (JP) 2018061123

(51) Int. Cl. G06F 16/2457; A41D 1/00

(52) U.S. Cl. CPC G06F 16/24575; G06K 9/00335; A41D 1/002

(57) ABSTRACT

A wearable gear design information retrieval system is provided which is suitable to achieve an effective reduction in workload in accordance with the details of a task of a worker and reduce costs. A suit design support apparatus inputs the type of movement of a design target person in a task (S100) and the data of the body of the design target person (S102), searches for a design file corresponding to the inputted movement type and body data (S104), and manufactures a work assist suit on the basis of the retrieved design file. Moreover, if the design file has not been retrieved (S106: N), a new design file is inputted (S112), and the inputted design file is registered associated with the inputted movement type and body data (S114).

### TECHNICAL FIELD

The present invention relates to a system for searching for design information of a suit, and particularly relates to a wearable gear design information retrieval system and suit design information retrieval system that is suitable to achieve an effective reduction in workload in accordance with the details of a task of a worker, and reduce costs.

### BACKGROUND ART

In recent years, there has been a trend toward aging workers with decreasing number of young people who are involved in the work. Especially, workers are aging at worksites of civil engineering works, construction works, and the like. Burdens on the workers are increasing. Material handling tasks associated with tasks requiring forward leaning postures place a heavy load on the legs and lower back. If these tasks are performed repeatedly or over long periods of time, they can lead to a risk of developing lower back pain and joint pain.

Hence, various work assist suits for reducing workloads of workers are conventionally known (Patent Literature 1).

A work assist suit described in Patent Literature 1 is provided with a body support elastic member 120 and a lower back support elastic member 130, which are placed along the body from the vicinity of the armpit to the vicinity of the waist, on a workwear main portion that covers the girth from the armpit to waist of a worker. When these elastic members are provided, it is possible to reduce a load applied to the back muscle and the legs and lower back as the worker moves his/her body, for example, bending, twisting, and turning, and to support a movement to return to the original position.

### CITATION LIST

### Patent Literature

PATENT LITERATURE 1: JP-A-2017-64335

### SUMMARY OF THE INVENTION

### Problems to be Solved by the Invention

The work assist suit described in Patent Literature 1 is provided with the elastic members at specific places on the workwear main portion. Accordingly, the workload on a specific movement can be reduced. However, workers move differently depending on the details of tasks at worksites such as civil engineering works and construction works, which does not necessarily lead to an effective reduction in workload for all workers.

Hence, the present invention has been made focusing on such an unsolved problem of the known technology, and an object thereof is to provide a wearable gear design information retrieval system and suit design information retrieval system that is suitable to achieve an effective reduction in workload in accordance with the details of a task of a worker, and to reduce costs.

### Solutions to the Problems

The present inventor has attained the present invention on the basis of the following information as a result of repeated diligent consideration.

In terms of the problem of the work assist suit described in Patent Literature 1, an approach to analyzing the type of movement performed in a task for each worker and designing positions where elastic members are provided and the number of elastic members, what is called a custom-made design, is conceivable. However, if a custom-made design is implemented, an expert needs to analyze which muscle is used on the basis of the movement of a worker in a task, how much load is applied to the muscle on the basis of, for example, the weight of the worker, and how many elastic members need to be provided at which positions to reduce the load, one by one. Hence, it may lead to an increase in cost as compared to a mass-produced product like the work assist suit described in Patent Literature 1.

A major cause of the increase in cost is the point that an expert needs to get involved in each design. In terms of this point, the present inventor thought it was possible to promote a cost reduction if one in some designs can be implemented mechanically without involvement of an expert. Hence, as a specific method, for example, what kind of design is implemented for what type of movement is stored in a database whenever a suit is designed and, next time a suit is designed, if the type of movement of a worker is analyzed, and design information corresponding to this movement type is gained by searching the database, a suit can be designed mechanically on the basis of the design information. Moreover, if, for example, a technology for detecting the state of a worker moving in an actual task by a sensor, and designing design information of a suit that reduces a workload applied to the worker due to this movement by AI (artificial intelligence), as in IoT (Internet of Things) technology, is assumed, it is possible to gain design information from AI by inputting movement type information (including sensor information) into AI. How AI learns needs to be deepened on the basis of a future study. However, AI should associate and learn the movement type information and the design information as the learning result. Accordingly, what kind of design has been implemented for what type of movement is to be stored in AI as a storage means.

Hence, the present invention is to solve not only the problem of the known technology but also the above expected problem resulting from the known technology by employing the following technical means.

### First Aspect

In order to achieve the above-described object, a wearable gear design information retrieval system according to a first aspect includes: a search means for searching a storage means where design information of wearable gear to be worn by a worker is stored associated with movement type information on the type of movement of the worker in a task and body information on the data of the body of the worker affecting a load on the body due to the task for the design information corresponding to the movement type information and the body information of a design target person.

Such a configuration allows the search means to search the storage means for design information corresponding to movement type information and body information of a design target person in a case of designing wearable gear to be worn by the design target person.

Here, the movement type information can be configured as, for example, information for identifying the type of movement in a task (for example, link information such as name, number, ID, code, and URL (Uniform Resource Locator)). Moreover, the movement type information can be configured as information such as character, numeric, figure, code, symbol, image, and audio. Moreover, the movement type information can be configured as a keyword related to the type of movement in a task (for example, one or more keywords representing the type of movement in a task), sensor information from a sensor placed on a suit or the like, or AI learning information (for example, information related to the structure of a learning network). The same applies below in the wearable gear design information retrieval system according to the third aspect, and a suit design information retrieval system according to the fifth and seventh aspects.

Moreover, the body information can be configured as, for example, information for identifying the data of the body (for example, link information such as name, number, ID, code, and URL). Moreover, the body information can be configured as information such as character, numeric, figure, code, symbol, image (including a still image or moving image; the same hereinafter), and audio. Moreover, the body information can be configured as a keyword related to the data of the body (for example, one or more keywords representing the data of the body), sensor information from a sensor placed on a suit or the like, or AI learning information (for example, information related to the structure of a learning network). The same applies below in the wearable gear design information retrieval system according to the fourth aspect, and the suit design information retrieval system according to the fifth and eighth aspects.

Moreover, to store the design information associating it with the movement type information and the body information includes, for example, (1) to store the design information, the movement type information, and the body information associating them directly by, for example, registering them in the same record, and (2) to store the information through one or more pieces of information at the halfway stage by, for example, providing a table for associating and registering the design information and intermediate information and a table for associating and registering the body information, the movement type information, and the intermediate information. In other words, any data structure can be employed as long as it has a form where the design information can be traced from the movement type information and the body information. In terms of the concept where information is associated and stored, the same applies hereinafter.

Moreover, the storage means is for storing the design information by every means at every timing, and may be one where the design information is stored in advance, or may be designed to store the design information by, for example, input from the outside during operation of the system without storing the design information in advance. The design information is simply required to be stored in the storage means, associated with the movement type information and the body information, and it is not necessarily required to store the movement type information and the body information in the storage means. The same applies below in the suit design information retrieval system according to the fifth aspect.

Moreover, a configuration including a search key obtaining means for obtaining, as a search key, the type of movement of a design target person in a task and the data of the body of the design target person, in which the search means searches for design information corresponding to a search key obtained by the search key obtaining means, can also be employed. Here, for example, the search key obtaining means may input a search key from an input apparatus or the like, may acquire or receive a search key from an external terminal or the like, may read a search key from a storage apparatus, a storage medium, or the like, or may generate or calculate a search key on the basis of information processing or the like. Therefore, obtaining includes at least input, acquisition, reception, read (including a search), generation, and calculation. In terms of the concept of obtaining, the same applies hereinafter.

Moreover, in the configuration including the search key obtaining means, the search key can be configured as information such as character, numeric, figure, code, symbol, image, and audio. Moreover, the search key is not limited to the same information as the movement type information and the body information, and can employ any information as long as it is information that can correspond with the movement type information and the body information. For example, (1) information on part of the movement type information and the body information, (2) information that allows gaining part or all of the movement type information and the body information by computation (for example, computation such as encoding, encryption, decoding, compression, or decompression), or (3) information that allows identifying the movement type information and the body information via another piece of information, can be employed. The same applies below in the suit design information retrieval system according to the fifth aspect.

Moreover, a configuration including an output means for outputting the design information retrieved by the search means can also be employed. Here, the output means can output the design information by methods such as display, printing, audio output, writing to a storage apparatus, a storage medium, or the like, transmission to an external terminal or the like, oscillations such as vibrations, and heat generation. Therefore, output includes at least display, printing, audio output, writing out, transmission, oscillations, and heat generation. In terms of the concept of output, the same applies hereinafter. The same applies below in the wearable gear design information retrieval system according to the third and fourth aspects and the suit design information retrieval system according to the fifth, seventh, and eighth aspects.

Moreover, the system may be realized as a single apparatus, terminal, or other devices, or may be realized as a network system to which a plurality of apparatuses, terminals, and other devices are connected in such a manner as to be capable of communication. In the latter case, each constituent element may belong to any of the plurality of devices or the like as long as it is connected in such a manner as to be capable of communication. The same applies below in the wearable gear design information retrieval system according to the third and fourth aspects and the suit design information retrieval system according to the fifth, seventh, and eighth aspects.

### Second Aspect

Furthermore, in the wearable gear design information retrieval system according to a second aspect in the wearable gear design information retrieval system according to the first aspect, the design information is design information of wearable gear that is designed in accordance with the type of movement of the worker in a task and body data affecting a load on the body of the worker due to the task.

### Third Aspect

Furthermore, a wearable gear design information retrieval system according to a third aspect includes a search means for searching a storage means where design information of wearable gear to be worn by a worker is stored associated with movement type information on the type of movement of the worker in a task for the design information corresponding to the movement type information of a design target person.

Such a configuration allows the search means to search the storage means for design information corresponding to movement type information of a design target person in the case of designing wearable gear to be worn by the design target person.

Here, the storage means is for storing the design information by every means at every timing, and may be one where the design information is stored in advance, or may be designed to store the design information by, for example, input from the outside during operation of the system without storing the design information in advance. The design information is simply required to be stored in the storage means, associated with the movement type information, and it is not necessarily required to store the movement type information in the storage means. The same applies below in the suit design information retrieval system according to the seventh aspect.

Moreover, a configuration including a search key obtaining means for obtaining, as a search key, the type of movement of a design target person in a task, in which the search means searches for design information corresponding to a search key obtained by the search key obtaining means, can also be employed. The same applies below in the suit design information retrieval system according to the seventh aspect.

Moreover, in the configuration including the search key obtaining means, the search key can be configured as information such as character, numeric, figure, code, symbol, image, and audio. Moreover, the search key is not limited to the same information as the movement type information, and can employ any information as long as it is information that can correspond with the movement type information. For example, (1) information on part of the movement type information, (2) information that allows gaining part or all of the movement type information by computation (for example, computation such as encoding, encryption, decoding, compression, or decompression), or (3) information that allows identifying the movement type information via another piece of information, can be employed. The same applies below in the suit design information retrieval system according to the seventh aspect.

### Fourth Aspect

Furthermore, a wearable gear design information retrieval system according to a fourth aspect includes a search means for searching a storage means where design information of wearable gear to be worn by a worker is stored associated with body information on the data of the body of the worker affecting a load on the body due to a task for the design information corresponding to the body information of a design target person.

Such a configuration allows the search means to search the storage means for design information corresponding to body information of a design target person in the case of designing wearable gear to be worn by the design target person.

Here, the storage means is for storing the design information by every means at every timing, and may be one where the design information is stored in advance, or may be designed to store the design information by, for example, input from the outside during operation of the system without storing the design information in advance. The design information is simply required to be stored in the storage means, associated with the body information, and it is not necessarily required to store the body information in the storage means. The same applies below in the suit design information retrieval system according to the eighth aspect.

Moreover, a configuration including a search key obtaining means for obtaining, as a search key, the data of the body of a design target person, in which the search means searches for design information corresponding to a search key obtained by the search key obtaining means, can also be employed. The same applies below in the suit design information retrieval system according to the eighth aspect.

Moreover, in the configuration including the search key obtaining means, the search key can be configured as information such as character, numeric, figure, code, symbol, image, and audio. Moreover, the search key is not limited to the same information as the body information, and can employ any information as long as it is information that can correspond with the body information. For example, (1) information on part of the body information, (2) information that allows gaining part or all of the body information by computation (for example, computation such as encoding, encryption, decoding, compression, or decompression), or (3) information that allows identifying the body information via another piece of information, can be employed. The same applies below in the suit design information retrieval system according to the eighth aspect.

### Fifth Aspect

Meanwhile, in order to the achieve above-described object, a suit design information retrieval system according to a fifth aspect includes a search means for searching a storage means where design information of a suit to be worn by a worker is stored associated with movement type information on the type of movement of the worker in a task and body information on the data of the body of the worker affecting a load on the body due to the task for the design information corresponding to the movement type information and the body information of a design target person.

Such a configuration allows the search means to search the storage means for design information corresponding to movement type information and body information of a design target person in the case of designing a suit to be worn by the design target person.

### Sixth Aspect

Furthermore, in the suit design information retrieval system according to a sixth aspect in the suit design information retrieval system according to the fifth aspect, the design information is design information of a suit that is designed in accordance with the type of movement of the worker in a task and body data affecting a load on the body of the worker due to the task.

### Seventh Aspect

Furthermore, a suit design information retrieval system according to a seventh aspect includes a search means for searching a storage means where design information of a suit to be worn by a worker is stored associated with movement type information on the type of movement of the worker in a task for the design information corresponding to the movement type information of a design target person.

Such a configuration allows the search means to search the storage means for design information corresponding to movement type information of a design target person in the case of designing a suit to be worn by the design target person.

### Eighth Aspect

Further, a suit design information retrieval system according to an eighth aspect includes a search means for searching a storage means where design information of a suit to be worn by a worker is stored associated with body information on the data of the body of the worker affecting a load on the body due to a task for the design information corresponding to the body information of a design target person.

Such a configuration allows the search means to search the storage means for design information corresponding to body information of a design target person in the case of designing a suit to be worn by the design target person.

### Effects of the Invention

As described above, the wearable gear design information retrieval system according to the first aspect allows designing wearable gear that effectively reduces workload in accordance with the details of a task of and the data of the body of a design target person as compared to before. Moreover, if design information is gained on the basis of a search, wearable gear can be designed mechanically without depending on an expert. Accordingly, a reduction in cost can be promoted as compared to a case of involving an expert in each design.

Furthermore, the wearable gear design information retrieval system according to the third aspect allows designing wearable gear that effectively reduces workload in accordance with the details of a task of a design target person as compared to before. Moreover, if design information is gained on the basis of a search, wearable gear can be designed mechanically without depending on an expert. Accordingly, a reduction in cost can be promoted as compared to the case of involving an expert in each design.

Furthermore, the wearable gear design information retrieval system according to the fourth aspect allows designing wearable gear that effectively reduces workload in accordance with the data of the body of a design target person as compared to before. Moreover, if design information is gained on the basis of a search, wearable gear can be designed mechanically without depending on an expert. Accordingly, a reduction in cost can be promoted as compared to the case of involving an expert in each design.

On the other hand, the suit design information retrieval system according to the fifth aspect allows designing a suit that effectively reduces workload in accordance with the details of a task of and the data of the body of a design target person as compared to before. Moreover, if design information is gained on the basis of a search, a suit can be designed mechanically without depending on an expert. Accordingly, a reduction in cost can be promoted as compared to a case of involving an expert in each design.

Furthermore, the suit design information retrieval system according to the seventh aspect allows designing a suit that effectively reduces workload in accordance with the details of a task of a design target person as compared to before. Moreover, if design information is gained on the basis of a search, a suit can be designed mechanically without depending on an expert. Accordingly, a reduction in cost can be promoted as compared to the case of involving an expert in each design.

Furthermore, the suit design information retrieval system according to the eighth aspect allows designing a suit that effectively reduces workload in accordance with the data of the body of a design target person as compared to before. Moreover, if design information is gained on the basis of a search, a suit can be designed mechanically without depending on an expert. Accordingly, a reduction in cost can be promoted as compared to the case of involving an expert in each design.

### BRIEF DESCRIPTION OF THE DRAWINGS

FIG. 1 is a diagram illustrating the configuration of a work assist suit 10.

FIG. 2 is a diagram illustrating the hardware configuration of a suit design support apparatus 100.

FIG. 3 is a diagram illustrating the data structure of a design information table 400.

FIG. 4 is a flowchart illustrating a suit design information retrieval process.

### DESCRIPTION OF THE EMBODIMENTS

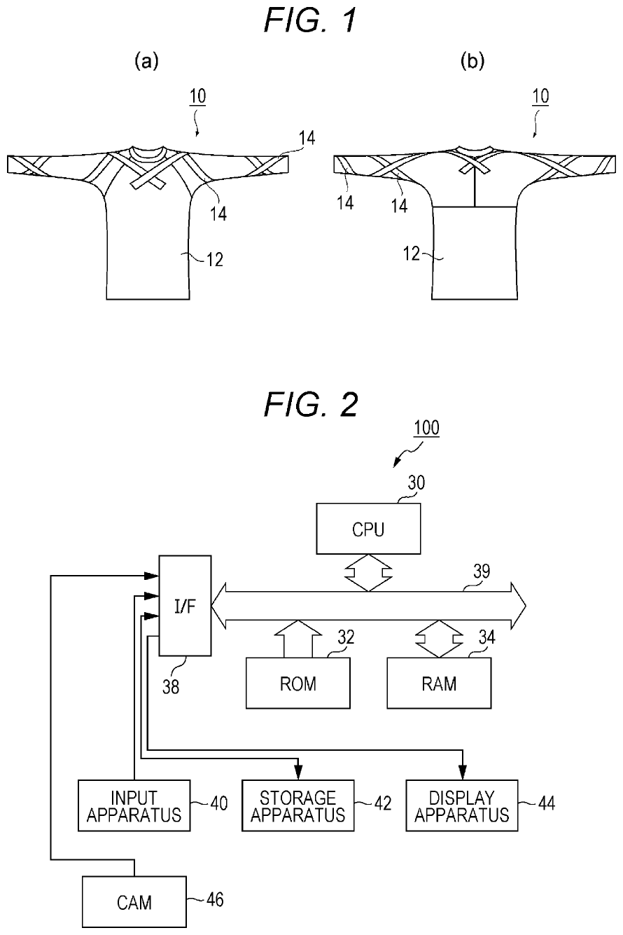

An embodiment of the present invention is described hereinafter. FIGS. 1 to 4 are diagrams illustrating the embodiment.

Firstly, the summary of the embodiment is described.

FIG. 1 is a diagram illustrating the configuration of a work assist suit 10. FIG. 1(a) is a front view of the work assist suit 10, and FIG. 1(b) is a rear view of the work assist suit 10.

The present invention is applied to the embodiment in a case where the work assist suit 10 of FIG. 1 is designed and manufactured in accordance with the task details, weight, and the like of each worker.

As illustrated in FIG. 1, the work assist suit 10 is based on compression wear 12, and is for preventing a reduction in muscle strength due to fatigue by applying a tape 14 in accordance with the details of a task of a worker since muscles used are different depending on the details of the task. For example, an elastic material made of special rubber can be used as the tape 14. An expert analyzes which muscle is used on the basis of the movement of a worker in a task, how much load is applied to the muscle on the basis of the weight and the like of the worker, and how many tapes 14 need to be applied at which positions on the compression wear 12 to reduce the load, and then designs the work assist suit 10. FIG. 1 illustrates an example where the tapes 14 are applied to the arms and the shoulders. However, the tapes 14 can be applied to the abdomen, the waist, the lower limbs, and other regions as necessary.

Next, the configuration of the embodiment is described.

FIG. 2 is a diagram illustrating the hardware configuration of a suit design support apparatus 100.

As described in FIG. 2, the suit design support apparatus 100 is configured including a CPU (Central Processing Unit) 30 that performs computations on the basis of a control program and controls the entire system, a ROM (Read Only Memory) 32 where, for example, the control program of the CPU 30 is stored in advance in a predetermined area, a RAM (Random Access Memory) 34 for storing data read from the ROM 32 and the like, and computation results required in the course of computation of the CPU 30, and an I/F (InterFace) 38 that mediates the input and output of data into/from an external apparatus. They are connected to each other by a bus 39 being a signal line for transferring data in such a manner to be capable of exchanging data.

The I/F 38 is connected, as the external apparatuses, an input apparatus 40 including a keyboard and a mouse that can input data as human interfaces, a storage apparatus 42 where data, a table, and the like are stored as files, a display apparatus 44 that displays a screen on the basis of an image signal, and a CAM (Computer Aided Manufacturing) 46 that manufactures the work assist suit 10.

Next, the data structure of the storage apparatus 42 is described.

Design information of the work assist suit 10 is stored as a design file in the storage apparatus 42. The design file is configured, for each tape to be applied to the compression wear 12, as, for example, a CAD (Computer Aided Design) file including coordinate information indicating the position, size, area, and the like of the tape.

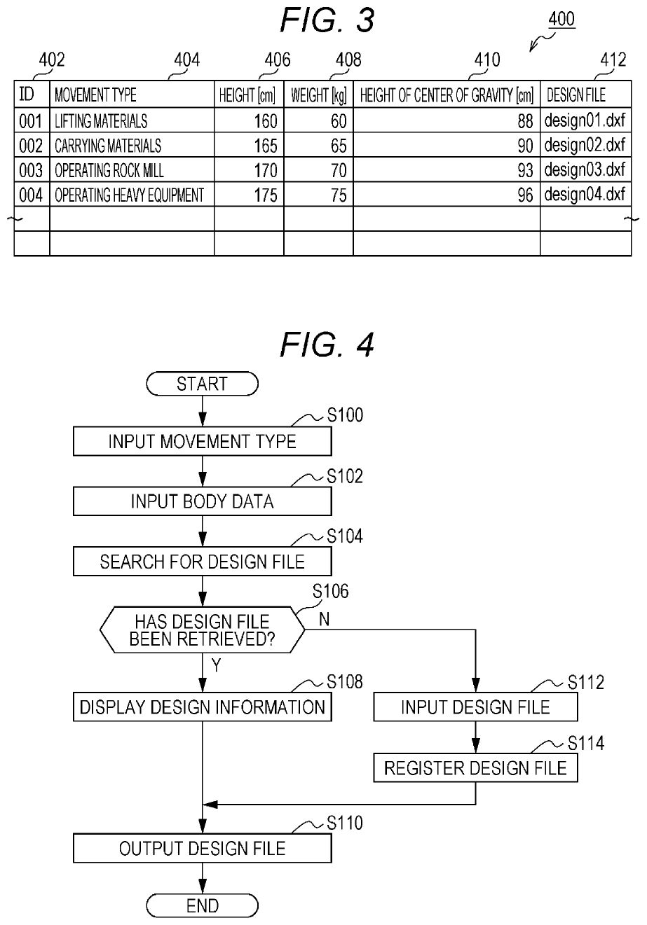

FIG. 3 is a diagram illustrating the data structure of a design information table 400.

As illustrated in FIG. 3, the design information table 400 is stored in the storage apparatus 42.

One record is registered for each design file in the design information table 400. Each record is configured including a field 402 for registering an ID uniquely assigned to a design file, a field 404 for registering the type of movement of a worker in a task, a field 406 for registering the height of the worker, a field 408 for registering the weight of the worker, a field 410 for registering the height of the center of gravity of the worker, and a field 412 for registering the file name of a design file corresponding to the type of movement and the data of the body in the fields 404 to 410.

Next, the operation of the embodiment is described.

The CPU 30 includes, for example, an MPU (Micro-Processing Unit), starts a predetermined program stored in a predetermined area of the ROM 32, and executes a suit design information retrieval process illustrated in a flowchart of FIG. 4 in accordance with the program.

FIG. 4 is the flowchart illustrating the suit design information retrieval process.

The suit design information retrieval process is a process that is executed at the request of a user. When the suit design information retrieval process is executed in the CPU 30, execution shifts first to step S100 as illustrated in FIG. 4.

In step S100, the type of movement of a design target person (worker) in a task is inputted from the input apparatus 40. For example, an expert interviews the design target person about the details of the task and analyzes the details, and then determines and inputs one or more types of movement from specified movement types such as “lifting materials,” “carrying materials,” “operating a rock drill,” and “operating heavy equipment.” The movement type can be, for example, managed in a master table, and registered, updated, or deleted as necessary.

Next, execution shifts to step S102. The height, the weight, and the height of the center of gravity are inputted as the data of the body of the design target person from the input apparatus 40. Execution shifts to step S104.

In step S104, the storage apparatus 42 is searched for a design file corresponding to the movement type and the body data, which were inputted in steps S100 and S102, with reference to the design information table 400. If two or more types of movement are inputted in step S100, the storage apparatus 42 is searched for a design file where all the types of movement are recorded in one record in the design information table 400.

Next, execution shifts to step S106. It is determined whether or not the design file was retrieved in step S104. If it is determined that the design file was retrieved (YES), execution shifts to step S108. Design information is displayed on the display apparatus 44 on the basis of the design file retrieved in step S104. If information to the effect that the displayed contents have been confirmed is inputted from the input apparatus 40, execution shifts to step S110.

In step S110, the design file retrieved in step S104, or a design file inputted in step S112, is outputted to the CAM 46. A series of steps is ended to return to the original process. The CAM 46 then manufactures the work assist suit 10 on the basis of the outputted design file.

On the other hand, if it is determined in step S106 that the design file was not retrieved in step S104 (NO), execution shifts to step S112. A new design file corresponding to the movement type and the body data, which were inputted in steps S100 and S102, is inputted. For example, an expert interviews the design target person about the details of the task and the body data and analyzes the task details and the body data. A CAD operator designs design information of the work assist suit 10 to be worn by the design target person by CAD on the basis of the analysis results by the expert. In step S112, the design information designed in this manner is inputted as a design file.

Next, execution shifts to step S114. The design file inputted in step S112 is stored in the storage apparatus 42. The movement type, the body data, and the file name of the design file, which were inputted in steps S100, S102, and S112, are registered in the design information table 400. Execution shifts to step S110.

Next, the effect of the embodiment is described.

In the embodiment, the type of movement of a design target person in a task and the data of the body of the design target person are inputted. A design file corresponding to the inputted movement type and body data is searched, and the work assist suit 10 is manufactured on the basis of the retrieved design file.

Consequently, the work assist suit 10 that effectively reduces workload in accordance with the details of a task of and the data of the body of a design target person as compared to before can be designed. Moreover, if a design file is acquired on the basis of a search, the work assist suit 10 can be designed mechanically without depending on an expert. Accordingly, a reduction in cost can be promoted as compared to a case of involving an expert in each design.

Furthermore, in the embodiment, if the design file has not been retrieved, a new design file is inputted, and the inputted design file is registered associated with the inputted movement type and body data.

Consequently, the number of chances to make further use of a design file can be increased with the increasing number of designs.

In the embodiment, the storage apparatus 42 corresponds to the storage means according to the first or fifth aspect. Step S104 corresponds to the search means according to the first or fifth aspect. The information in the field 402 corresponds to the movement type information according to the first or fifth aspect. The information in the fields 404 to 408 corresponds to the body information according to the first or fifth aspect.

### Modifications

In the above embodiment, the evaluation of the work assist suit 10 is not particularly described. However, with improvements in expert skills and design technology, it is expected to be able to design the work assist suit 10 that reduces workload further even for the same movement type and body data. Accordingly, a configuration can be employed in which the work assist suit 10 is evaluated, and a search is performed using the evaluation information. A specific configuration thereof is described below.

A design file is stored in the storage apparatus 42, associated with a movement type, body data, and evaluation information related to the evaluation of the work assist suit 10 designed on the basis of the design file. The type of movement of a design target person in a task and the data of the body of the design target person are inputted. A design file and evaluation information, which correspond to the inputted movement type and body data, are searched. Design information is displayed on the basis of the retrieved design file and evaluation information. For example, the following configurations can be employed as a method for displaying design information.

The first configuration displays design information in descending order of evaluation of evaluation information. Consequently, if there is a plurality of design files corresponding to the same movement type and body data, it is easy to grasp highly evaluated design information.

The second configuration displays design information in ascending order of evaluation of evaluation information. Consequently, if there is a plurality of design files corresponding to the same movement type and body data, it is easy to grasp low evaluated design information.

The third configuration calculates the position of an evaluation (for example, a T-score of an evaluation value) of a relevant work assist suit 10 in all the evaluations of the work assist suits 10, and displays design information, associating the design information with the calculated position. Consequently, the position in all the evaluations can be grasped. Accordingly, it is easy to judge whether to make further use of a design file or newly design the work assist suit 10. For example, if the T-score is 50 or greater, a design file acquired by a search is used. If the T-score is less than 50, a new work assist suit 10 is designed, and a new design file is registered. Such a configuration allows updating registered contents of a design file in step with improvements in expert skills and design technology.

The work assist suit 10 may be evaluated from a personal point of view of a worker who wore the work assist suit 10, or may be evaluated on the basis of sensor information gained from a sensor that detects the states of a worker moving and using muscles in an actual task, the sensor being placed on the work assist suit 10, in a worksite, or the like.

Moreover, in the above embodiment and the modifications thereof, a design file is stored associated with a movement type and body data. However, the present invention is not limited to this. A design file may be stored associated with a movement type. This is, for example, a case where a design operation is set for each set of body data, and the work assist suits 10 of the same data are designed by one design operation. In this case, the type of movement of a design target person is inputted, and a design file corresponding to the inputted movement type is searched.

Moreover, in the above embodiment and the modifications thereof, a design file is stored associated with a movement type and body data. However, the present invention is not limited to this. A design file may be stored associated with body data. This is, for example, a case where a design operation is set for each movement type, and the work assist suits 10 of the same movement type are designed by one design operation. In this case, the data of the body of a design target person is inputted, and a design file corresponding to the inputted body data is searched.

Moreover, in the above embodiment and the modifications thereof, the height, the weight, and the height of the center of gravity are presented as the data of the body. However, the present invention is not limited to this. Any data can be employed as long as it is data of the body of a worker affecting a load on the body due to a task. A method for defining data is not at all limited, and any method can be employed.

Moreover, in the above embodiment and the modifications thereof, one or more movement types among the specified movement types such as “lifting materials,” “carrying materials,” “operating a rock drill,” and “operating heavy equipment” are inputted as the types of movement in a task. However, the present invention is not limited to this. A more specific detail may be set. A method for defining a movement type is not at all limited, and any method can be employed.

Moreover, in the above embodiment and the modifications thereof, the present invention is carried out as the suit design support apparatus 100 being a single apparatus, but is not limited to this, and can also be carried out as a network system. A suit design support server and a plurality of user terminals are connected to a network such as the Internet. The suit design support server is configured including a function equivalent to the suit design support apparatus 100. The differences are a point of receiving information from the user terminal instead of input from the input apparatus 40, and a point of transmitting information to the user terminal instead of display on the display apparatus 44.

Moreover, in the above embodiment and the modifications thereof, the case of executing the program stored in advance in the ROM 32 upon executing the suit design information retrieval process illustrated in the flowchart of FIG. 4 has been described. However, the present invention is not limited to this. It may be designed to read a program presenting these procedures from a storage medium where the program is stored into the RAM 34 and execute the program.

Here, the storage medium is a semiconductor storage medium such as RAM or ROM, a magnetic storage-type storage medium such as an FD or HD, an optical reading-type storage medium such as a CD, CDV, LD, or DVD, or a magnetic storage-type/optical reading-type storage medium such as an MO, and includes every storage medium as long as it is a computer-readable storage medium regardless of a reading method such as electronic, magnetic, and optical reading.

Moreover, in the above embodiment and the modifications thereof, the present invention has been applied to the case of designing and manufacturing the work assist suit 10. However, the present invention is not limited to this, and can also be applied to other cases within the scope that does not depart from the gist of the present invention. The present invention can be applied to, for example, a case of designing a suit with another structure such as the work assist suit described in Patent Literature 1. Moreover, the present invention can be applied to a case of reducing the load of every task in agriculture, caregiving, material handling at factories, and carrying objects for moving house.

Moreover, the present invention can be widely applied to not limited to design information of a suit but design information of wearable gear to be worn by a worker. The wearable gear includes, for example, clothing and footwear. The clothing includes, for example, work assist suits and other suits, clothes, coats, sweaters and the like, shirts and the like, sleeping wear and the like, underwear, swimming wear, swimming caps, camisoles, T-shirts, Japanese clothes, eye masks, aprons, comforters, socks, gaiters, fur stoles, shawls, scarves, Japanese split-toed socks, Japanese sock covers, gloves, ties, neckerchiefs, bandannas, moisture retention supporters and other supporters, mufflers, earmuffs, nightcaps, and caps and hats. The footwear includes, for example, shoes and the like, and Japanese wooden sandals, Japanese woven sandals and the like. Other wearable gear includes, for example, garters, suspenders for stockings, suspenders for trousers, bands, and belts.

As an example, if a glove among the wearable gear is targeted, for example, the following configuration can be employed. Design information of a work assist glove is stored as a design file in the storage apparatus 42. The design file is configured, for each tape applied to the glove, as, for example, a CAD file including coordinate information indicating the position, size, area, and the like of the tape. A glove design support apparatus inputs the type of movement (for example, “lifting materials”) of a design target person in a task and the data of the body (for example, the size of the hand) of the design target person, searches for a design file corresponding to the inputted movement type and body data, and manufactures a work assist glove on the basis of the retrieved design file. Moreover, if the design file has not been retrieved, a new design file is inputted, and the inputted design file is registered associated with the inputted movement type and body data.

Moreover, as an example, if, for example, a sock among the wearable gear is targeted, for example, the following configuration can be employed. Design information of a work assist sock is stored as a design file in the storage apparatus 42. The design file is configured, for each tape applied to the sock, as, for example, a CAD file including coordinate information indicating the position, size, area, and the like of the tape. A sock design support apparatus inputs the type of movement (for example, “lifting materials”) of a design target person in a task and the data of the body (for example, the size of the foot) of the design target person, searches for a design file corresponding to the inputted movement type and body data, and manufactures a work assist sock on the basis of the retrieved design file. Moreover, if the design file has not been retrieved, a new design file is inputted, and the inputted design file is registered associated with the inputted movement type and body data.

In these modifications, the case where a glove or sock is designed by applying tapes to the glove or sock has been illustrated. However, the present invention is not limited to this. For example, a glove or sock can also be designed by adjusting the thickness, size, and the like of the glove or sock. A method for designing an object and the configuration of a design file are arbitrary.

### LIST OF REFERENCE NUMERALS

100 Suit design support apparatus

30 CPU

32 ROM

34 RAM

38 I/F

39 Bus

40 Input apparatus

42 Storage apparatus

44 Display apparatus

46 CAM

400 Design information table

1. A wearable gear design information retrieval system comprising a search means for searching a storage means where design information of wearable gear to be worn by a worker is stored associated with movement type information on the type of movement of the worker in a task and body information on the data of the body of the worker affecting a load on the body due to the task for the design information corresponding to the movement type information and the body information of a design target person.

2. A wearable gear design information retrieval system comprising a search means for searching a storage means where design information of wearable gear to be worn by a worker is stored associated with movement type information on the type of movement of the worker in a task for the design information corresponding to the movement type information of a design target person.

3. A wearable gear design information retrieval system comprising a search means for searching a storage means where design information of wearable gear to be worn by a worker is stored associated with body information on the data of the body of the worker affecting a load on the body due to a task for the design information corresponding to the body information of a design target person.

4. A suit design information retrieval system comprising a search means for searching a storage means where design information of a suit to be worn by a worker is stored associated with movement type information on the type of movement of the worker in a task and body information on the data of the body of the worker affecting a load on the body due to the task for the design information corresponding to the movement type information and the body information of a design target person.

5. A suit design information retrieval system comprising a search means for searching a storage means where design information of a suit to be worn by a worker is stored associated with movement type information on the type of movement of the worker in a task for the design information corresponding to the movement type information of a design target person.

6. A suit design information retrieval system comprising a search means for searching a storage means where design information of a suit to be worn by a worker is stored associated with body information on the data of the body of the worker affecting a load on the body due to a task for the design information corresponding to the body information of a design target person.
